(19) United States
(12) Patent Application Publication
(10) Pub. No.: US 2012/0091199 A1
(43) Pub. Date: Apr. 19, 2012

(54) Multi-account card system

(75) Inventor: Albert Talker, New York, NY (US)

(73) Assignee: Albert Talker, New York, NY (US)

(21) Appl. No.: 12/906,094

(22) Filed: Oct. 17, 2010

(51) Int. Cl. G06K 5/00

(52) U.S. Cl. 235/380

(57) ABSTRACT

A multi account system consisting of master accounts linked to multiple accounts wherein account data is stored in a data storage card and in a central database. The central database may also store a plurality of secret keys and or public/private key sets associated with the accounts in addition to optional BIO information, which can be used for authentication and authorization.

### FIELD OF THE INVENTION

This invention relates to multi-account system for conducting business transactions and for account verifications. Specifically this invention relates to a transaction system, which enables a single card to be used as a substitute for a plurality of conventional credit cards, identification cards, membership cards, loyalty cards, benefit cards and other purpose cards. Multi account authentication and authorization is achieved by comparing entered data against one or more data elements stored within a central database and data stored in a data storage card.

### BACKGROUND OF THE INVENTION

The most common types of credit and debit cards in use today are magnetic stripe type cards. The standardized format used for such cards includes indicia on a front side of the card. Such indicia identify the card owner, an account number, a card type, a card issuer, an expiration date as well as possibly other information. Such indicia are presented as raised letters and numbers which can be used to make an impression on a multipart carbon or carbonless form. The rears of such cards have a magnetic stripe supported thereon. The magnetic stripe includes several tracks of information. This information includes magnetic indicia representative of the information found on the front of the card as well as other information that is used in processing transactions electronically. Magnetic stripe cards are commonly used for credit card types such as MasterCard.®., VISA.®., Discover.®., American Express.®., Diner's Club.®. and others.

Most people also carry debit cards, which allow them to access money in their checking, and savings accounts using automated banking machines. Some debit cards also function as credit cards. Most debit cards in use today are magnetic stripe cards similar in format to credit cards.

Due to the convenience of using credit and debit cards most people carry several such cards in their wallet. Because of financial incentives associated with the issuance and sponsorship of credit cards, many users are offered cards by different banks, clubs, fraternal organizations and merchandising organizations. As a result it is not uncommon for people to have several different MasterCard.®. and VISA.®. accounts. This gives consumers the opportunity to take advantage of premiums such as frequent flyer miles and rebates offered by card sponsors. Having several different credit cards also enables consumers to take advantage of the credit limits on all their cards. While having many credit and debit cards is a benefit to consumers, it also requires them to carry several cards.

Most individuals also carry a number of other objects or cards, which include machine-readable indicia. These often include for example, a health insurance card, which indicates that a person is a member of a particular group insurance plan. Such cards are often magnetic stripe cards similar to credit cards. Alternatively such health insurance cards may include bar code indicia or other visible indicia, which can be read with a scanner. Some health insurance cards include both visible and magnetic indicia. Persons who are members of a health insurance plan can identify themselves and their account to medical providers by showing their card, which can be read or scanned by appropriate devices.

Persons also commonly carry other types of cards with visible or magnetic indicia. These may include for example, library cards, identification or access cards, employee identification cards, student identification cards, driver's license cards, professional license cards and other types of card like objects. The magnetic or visible indicia on these cards are usually read when presented by the cardholder to identify the person as an authorized user of services or facilities.

Another type of card, which has been developed, is the stored value card commonly referred to as a “smart card”. Stored value cards are similar to credit and debit cards in construction in that they include a front side which has raised identifying indicia which can be transferred to a carbon or carbonless multipart form. Such cards also commonly include a magnetic stripe including magnetic indicia; which enables the card to work like any other credit or debit card. Stored value cards also include a programmable memory mounted on the card. Such programmable memory stores data representative of cash value. The value on the stored value card can be used like cash by the bearer to purchase goods or services. The stored value data on the card is also often encrypted or stored using schemes to prevent fraud or tampering therewith.

Stored value cards, like debit and credit cards, require the customer to interact with a stationary terminal device to utilize the card. For example, in the case of credit cards, credit is obtained when the customer presents their card to a merchant. The merchant (unless they process transactions manually) utilizes a point of sale or electronic funds transfer terminal to charge an amount to the customer's account and credit the merchant's account. Similarly the use of a debit card requires that the user present their card to an automated banking machine such as an ATM. The ATM operates to add or deduct amounts from the user's account as funds are deposited or received by the user. Similarly, stored value cards are used in connection with a stationary terminal device such as an electronic funds transfer terminal or automated banking machine which has the special capabilities to handle the particular type of stored value card used. The terminal modifies the value information stored in memory on the card to reflect the addition or subtraction of value represented thereon as transactions are conducted.

Thus there exists a need for a system and a method that can reduce the number of credit, debit and other cards or card like objects that a person must carry while still obtaining the benefit of carrying all such cards and objects.

There further exists a need for an apparatus and method, which gives a single card the ability to be used as a substitute for any one of a plurality of credit, debit or other cards.

Finally there further exists a need for an apparatus and method for carrying out transactions with added security features for authentication and authorization.

The many attempts at providing a smart, secure credit card system in the past have proven too user unfriendly or unreliable, and this is believed why such cards have not gained user acceptance.

Unlike the prior art, the present invention provides an easily implemented system with multiple accounts, which utilizes some of the features of the standard credit/debit or loyalty card.

A listing of patents which are believed to have some pertinence to the present invention follow:

| Pat. No. | Inventor | Date of Issue |
|---|---|---|
| 6,954,740 | Talker (The inventor | Oct. 11, 2005 |
| | of this application) | |
| 5,326,964 | | |
| 5,317,636 | | 1994 |
| 5,276,311 | Hennige | Jan. 04, 1994 |
| 5,255,941 | Solomon | Oct. 26, 1993 |
| 4,947,027 | Kashkashian, Jr | Oct. 13, 1987 |
| 4,707,594 | Roth | Nov. 17, 1987 |
| 4,697,073 | Hara | Sep. 29, 1987 |
| 4,587,413 | Hoppe et al | May 06, 1986 |
| 3,902,262 | Colegrove et al | Sep. 02, 1975 |
| 3,833,929 | Kirley | Sep. 03, 1974 |

### CROSS-REFERENCES TO RELATED APPLICATIONS

The present application also incorporates by reference for all purposes the entire contents of U.S. application Ser. No. 11/349,655 filed on Feb. 8, 2006.

U.S. Pat. No. 6,954,740 issued in 2005 issued to the undersigned inventor teaches an “Action verification system using central verification authority” which does not include a multi account card. This current invention disclosure teaches of a “Multi Account Card” which can be cross-referenced to U.S. Pat. No. 6,954,740.

U.S. Pat. No. 5,255,941 issued in 1993 teaches an “Antifraud Credit Card Assembly” teaching a card, which includes a slidingly removable magnetic strip, to prevent unauthorized use of said card. Without the magnetic strip, the card is recognized as unusable. The present invention made subject this application differs in both method and apparatus for accomplishing the security verification, and card structure.

U.S. Pat. No. 5,326,964, apparently teaches a “Separable multi-account safety credit card system”, wherein the account numbers and the card are “mechanically detachable into two component parts, whereby that part upon which is embossed the credit account numbers may be separately carried from the individual identification part . . . ” to prevent unauthorized transactions. The present invention made subject this application differs in both method and apparatus for accomplishing the security verification, and card structure.

U.S. Pat. Nos. 5,317,636 and 5,276,311 teach smart credit cards having a QUERTY keypad or the like thereon for entry of passwords, and displays for indicating account information, signature information, or the like.

U.S. Pat. Nos. 4,697,073 teaches a credit card which appears to have separable the electronics, along with contact means for communicating with the verifying equipment.

The remaining patents cited are included for general information and research purposes, teaching various credit card systems, but do not appear to be as pertinent as the above-cited patents.

### GENERAL SUMMARY DISCUSSION OF THE INVENTION

Unlike the prior art, the present invention contemplates a multi account verification and authentication card system which is flexible in its various alternative uses, effective in promoting security, easy to use, and relatively inexpensive to produce and maintain.

The above patents may contemplate various alternative card systems, some programmable, some having removable indicia (magnetic or raised), but none contemplate the present system wherein the data storage card has a capacity to handle 1 or more accounts and one or more data storage devices linked to multiple vendors and financial organizations.

The preferred embodiment of the present invention teaches a multi-account card body having the same basic dimensions and the same physical appearance of a standard credit card. As will be set forth below, an alternative embodiment of the present invention is also contemplated which utilizes a data storage card which includes multiple accounts and sets of PINs/Keys stored in its memory.

As will be set forth below, an alternative embodiment of the present invention is also contemplated which utilizes a smart card which includes account and BIO data transmission mechanism.

As will be set forth below, an alternative embodiment of the present invention is also contemplated which utilizes a smart card which includes the one or more accounts, PINs and BIO data stored in storage means and data transmission mechanism used to transmit/receive the stored data

It is thus an object of the present invention to provide a multi account security verification system which is inexpensive to manufacture, and easy to operate.

It is another object of the present invention to provide a secure multi account card system, which effectively prevents unauthorized access to valuable account data.

It is another object of the present invention to provide a secure multi account card system comprising display means, which lists accounts on the card's body.

It is another object of the present invention to provide a method for preventing card theft, utilizing a virtual account number for accessing real account numbers stored on a central database, and means for capturing and transmitting BIO data which could be further used for authentication and authorization.

It is another object of the present invention to allow the use of a PIN/KEY, which can be used to validate an Entity's identity and its authorization through the use of a PIN/KEY stored in the data storage card or in a central database.

It is therefore a further object of this invention that the system has sufficient mobile capabilities so as to allow an Entity to authorize a transaction and enter a transaction PIN/KEY at various locations and through electronic.

For the foregoing reasons, there is a need for an easily implemented system with a multiple account data storage card that can process multiple accounts, which utilizes some of the features of the standard card, but without the necessity of the entity having to be computer literate, while preventing unauthorized transactions. It is to such a system that the present invention is directed.

### BRIEF DESCRIPTION OF THE DRAWINGS

FIG. 1 is a schematic, diagrammatic view of a multi-account system operating in accordance with the present invention, showing a central database with a PIN list and vendors' connections to the central database.

FIG. 2 is a schematic, diagrammatic view of a multi-account system operating in accordance with the present invention, showing a central database with a PIN list, a financial enterprise/clearing agent and vendors' connections to the central database.

FIG. 3 is a schematic, diagrammatic view of a multi-account system operating in accordance with the present invention, showing a central database and vendors' databases, a financial enterprise/clearing agent and the vendors' connections to the central database.

FIG. 4 is a schematic, diagrammatic view of a multi-account system operating in accordance with the present invention, showing the central database and the vendors' databases, the financial enterprise/clearing agent and the vendors' connections to the central database. In addition a schematic view showing a smart card (Integrated Circuit computer) with a PIN/Key list stored in its memory and a card input means entered by an entity using input devices.

FIG. 5 is a schematic, diagrammatic view of another embodiment of a multi-account system operating in accordance with the present invention, showing the central database and the vendors' databases, the financial enterprise/clearing agent database and the vendors' connections to the central database. In addition a schematic view showing a smart card (Integrated Circuit computer) with a PIN/Key list stored in its memory and card input means entered by an entity using input devices. It also shows optional terminal links and optional BIO identification unit embedded in the card.

For a further understanding of the nature and objects of the present invention, reference should be had to the following detailed description, taken in conjunction with the accompanying drawings, in which like parts are given like reference numerals.

### DETAILED DESCRIPTION OF THE INVENTION

Definitions of Terms

Vendor (6)—The term “Vendor” as used herein means an individual, company, vendor, bank, financial entity or other Entity.

Security Verification—The term “Security Verification” as used herein means validation of Entity's identity, account number verification, and authorization of a transaction.

Entity (2)—The term “Entity” as used herein means an individual, company, vendor or other.

Transaction—The term “transaction” as used herein means a transaction authorized by an Entity, which can be requested and/or transmitted and/or delivered and/or executed electronically or mechanically. Wherein transaction includes a financial transaction, message, command, non-financial transaction, approval, identification request, real account request, and data approval.

Computer System AND Computer AND Programmed Logic Systems—The term “Computer System” and “Computer” and “Programmed Logic Systems” as used herein means a system or systems, which are able to embody and/or execute the logic of the processes, described herein. The logic embodied in the form of software instructions or firmware may be executed on any appropriate hardware which may be a dedicated system or systems, or a general purpose computer system, or distributed processing system, all of which are well understood in the art, and a detailed description of how to make or use such computers is not deemed necessary herein. It should be noted that the Vendors Databases, and Central Database as described herein may be embedded within a single computer or programmed logic system, or be implemented as separate computers or programmed logic systems, or be executed on multiple systems using any of the distributed processing models as are well understood in the art, or be implemented using any mixture of the above.

Financial Enterprise/Clearing Agent—Vendor (8)—The term “Financial Enterprise/Clearing Agent” as used herein means an company, organization or other Entity which can embed and communicate with systems which embed the information and/or processes requiring verification of account and transaction data together with the procedural capability to perform such security verification and transaction authorization of transactions linked to accounts belonging to an entity.

Account—The term “Account” as used herein means a conventional credit or debit card accounts, checking accounts, financial accounts, identification card accounts, membership card account, benefit cards accounts and other objects which include account number.

Communication Link/Computer Network (32)—The term “communication link” interchangeably referred also as “Computer Network” refer to any suitable communication link, which permit communications (e.g. Internet, computer network, telephone). It should be understood that the term “communication link” is not limited to “Internet” or any other particular system or type of communication link. That is, the term “communication link” is intended only to refer to any suitable communication system, including extra-computer system and intra-computer system communications. Examples of such communications systems include internal busses, local area networks, wide area networks, point-to-point shared and dedicated communications, infra-red links, microwave links, telephone links, CATV links, Satellite and radio links and fiber-optic links. The term “communication link” can also refer to any suitable communication system for sending messages between remote locations, directly or via a third party communication provider such as AT&T. In this instance, messages can be communicated via telephone or facsimile or computer synthesized voice telephone messages with or without voice or tone recognition, or any other suitable communications technique.

It should be understood that each of the communication links are shown and described separately herein for the sole purpose of clearly illustrating the information being communicated between the Central Database, the Vendors and the Entity. In operation, the communication links may not be separate communication links but may be a single communication link.

“PIN”—The term “PIN” or “Pin” or KEY or PIN/KEY refer to Personal Identification Numbers, Key Codes, public/private keys or Tokens. Each Entity will have sets of individualized PINs/Keys linked to his virtual account which one of them may be uniquely associated with, or identify a particular transaction, activity or other item that needs security verification. The PINs/Keys may be stored with it virtual account number suitable for identifying a particular transaction. These PINs/Keys may be generated using a predetermined strategy or arbitrary generated by a computer. The PINs/KEYs may include a predetermined strategy formula to generate further sets of PINs/KEYs that can be used to verify future transactions. The Entity can only perform the selection of the appropriate formula. PINs/KEYs can also be supplied to the Entity by a form of printed list or labels, or by using electronic means wherein the Entity may able to select a PIN/KEY and supply the PIN/KEY to the merchant.

BIO data—The term “BIO” as used herein means any personal BIO data or BIO identification confirmation data including finger prints, retinal scan, face recognition, voice identification, and other personal identification features.

Description of Components

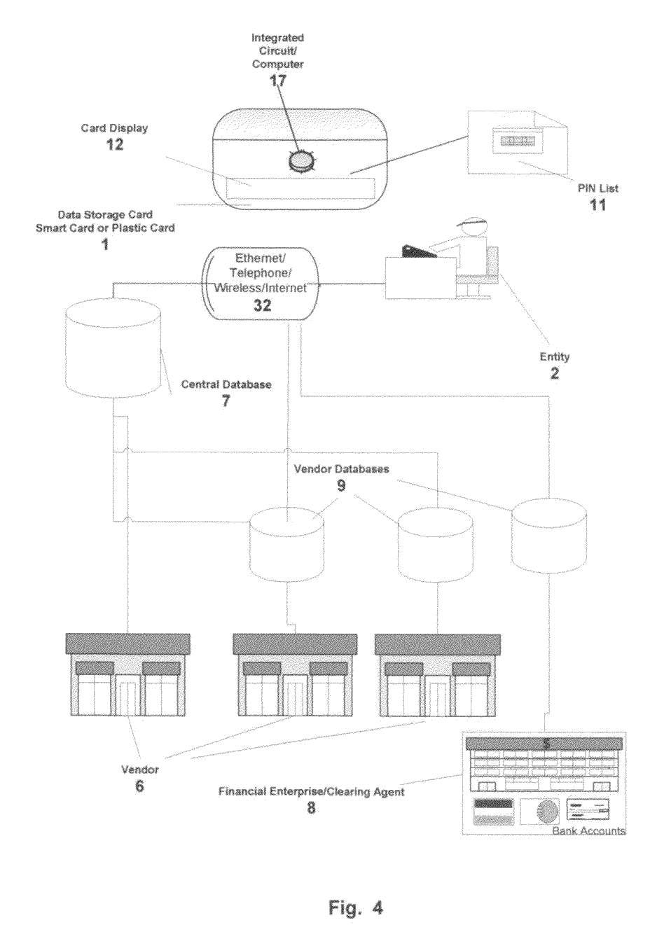

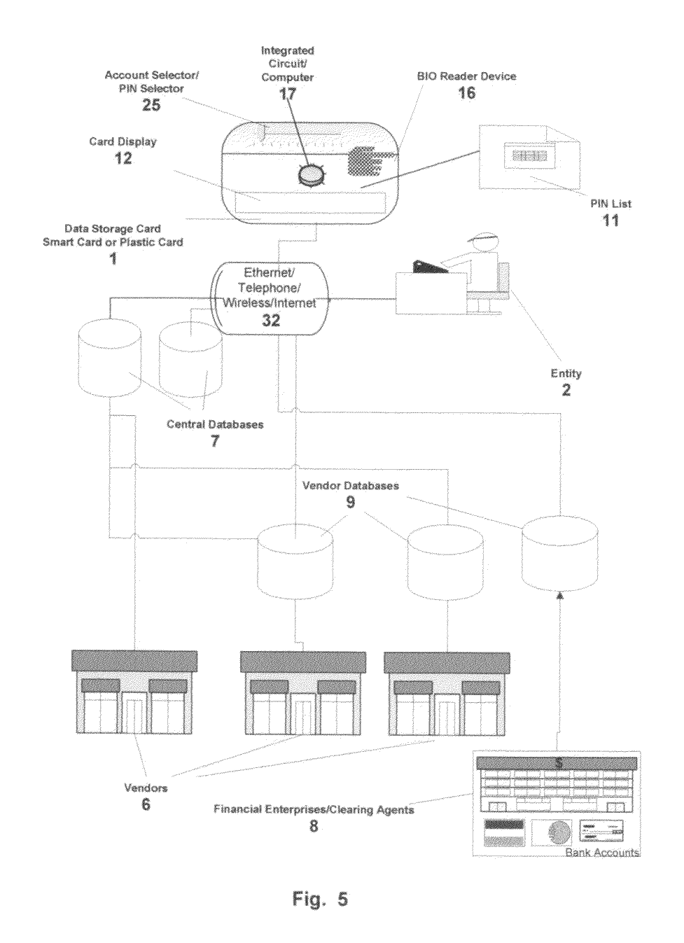

MULTI-ACCOUNT CARD≦Data Storage Card/smart Card or Conventional Plastic Card—REFERRING TO FIG. 4-FIG. 5.

The multi-account card 1 may have the dimensional configuration of conventional credit and debit cards. It can include one or more magnetic stripes and one or bar-code prints on a rear or front face thereof. The magnetic stripes are capable of holding one or more magnetic indicia similar to the magnetic stripes on conventional debit, credit and similar cards. The bar-code print is capable of holding account data similar to the data held in magnetic stripes on conventional debit, credit and similar cards.

As later explained, multi-account card 1 is designed to be used as a substitute for a plurality of varied types of credit, debit and other cards. However, in embodiments of the invention, card 1 may include information on the face or rear thereof so as to identify the particular user to whom the card belongs, an issuer of the card, as well as other data. In some embodiments, the front side of the card may include raised numbers and letters corresponding to a particular account. In some embodiments, the front side of the card may include printed, glue labeled, or embossed (raised) captions including numbers and letters, corresponding to real accounts titles/names linked to the particular virtual account.

For example, information on the face of the card may correspond to a user's MasterCard.®., VISA.®., American Express.®., Discovery.®., checking accounts ,investment accounts, or other accounts. This enables the exemplary card to be used as the user's regular credit card when purchasing goods or services in establishments that do manual processing of credit card transactions. Of course while in the embodiment discussed, conventional credit card indicia may be included on the front of the card, in other embodiments special indicia may be presented on the card.

As shown in FIGS. 4 and 5 the card further includes terminal links which are used to communicate data with the smart card memory. In the embodiment shown, the memory reading and writing functions are combined schematically and are schematically shown. However, it should be understood that these are separate functions and may be carried out through separate arrangements of hardware and software. The card 1 further includes the hardware and software devices required to read data from and write data into the card's data storage memory. The memory data includes the accounts data, linked account names, and PINS/KEYs list 11 linked to the accounts.

As shown in FIG. 5 in the embodiment shown, the card may further include an input device, which includes a manual input device for selecting Account/PIN. The card also includes an electronic display screen 12 on the front face thereof. In one exemplary form of the invention electronic display screen 12 is an LCD type display or other suitable display that may be used for displaying words, graphics and other visible indicia in a manner later explained. When pressing the button or slider 25, the electronic display screen 12 begins a scrolling through the listed accounts in memory. The card then will display the required PIN in the display screen 12 used to select the corresponding account and further can be used for authentication. The card may include only buttons to scroll up/down (button or slider 25). These scroll up and scroll down buttons, are pressed by a user to selectively display items on the display. The card can be used to transmit the required PIN and the account to the Vendors 6 using data communications means 32.

The card's memory may further include data representative of visual indicia, which are found on a plurality of cards or other objects associated with the virtual account. The visible indicia may include for example, bar code indicia representative of a user's account. Alternatively such visible indicia may include bar code, alpha numeric accounts or other indicia associated with a membership I.D., Credit Cards, Checking Accounts, student.I.D., employee access card, driver's license, or other types of objects. The visible indicia displayed using display screen 12 may also include account data, or other data. The card memory may also include data representative of icons or other graphics as well as data representative of real accounts stored in the Central Database 7

Alternative embodiments of the invention may include a bio reader device 16. The bio reader device may include hardware and software components that can be used to sense a characteristic of a user, which uniquely identifies the person as an authorized user. In some embodiments the biometric reader device 16 may include a fingerprint reading device. Alternatively, the reader may include an audio input device, which can be used to identify a user by voice. Alternatively, visual readers for identifying unique visible features or a combination of identifying features of the user may be used. The memory of the card may include data representative of the identifying biometric features of the authorized user or users. This stored data is used to enable authorized users of the card to operate the card while others are prevented from such operation. In addition, terminal means can be used to send bio data to the Central Database 7 or the Vendors' database 6 for further authentication and data transfer.

For example, if the biometric reader is a fingerprint reader, the user may be prompted to bring a finger that they have pre-selected adjacent to the reader. The bio reader 16 would read the fingerprint and produce suitable signals to compare the input data to the data stored on the card. If the input data corresponds to an authorized user, the user is authorized to further operate the card. Alternatively in another embodiment, the bio data will be sent to the Central Authentication Enterprise and then compared to BIO data stored in its database, which can be used for further authentication

Terminal means and communication means 32 many include wireless means so data can be transmitted from the entity's hand-held card to a vendor's database 6 and the Financial enterprise 8. The card 1 can also have security measures to prevent unauthorized access for usage of the card. For example, a card user may be required to provide at least one identifying input prior to being permitted to use the card. This may include the card user providing a biometric input, such as a fingerprint, to the card, or input a pass code before using the card.

Data Input Devices

The input devices used by entity 2, used to input or receive data from the card 1 or the central database 7 or the vendor's databases 9 can include any one or more of the following:

1. Portable terminal.

2. Keyboard

3. Keypad

4. Modem

5. Computer

6. Laptop

7. PDA

8. Voice Recognition mechanism

9. Cam Camera

10. Bar Code Reader

11. Magnetic stripe reader

12. Scanner

13. Digital Input

The input device is preferably sufficiently small so as to be readily portable. The input devices operates in conjunction with the card or alternatively can be built in the card 1.

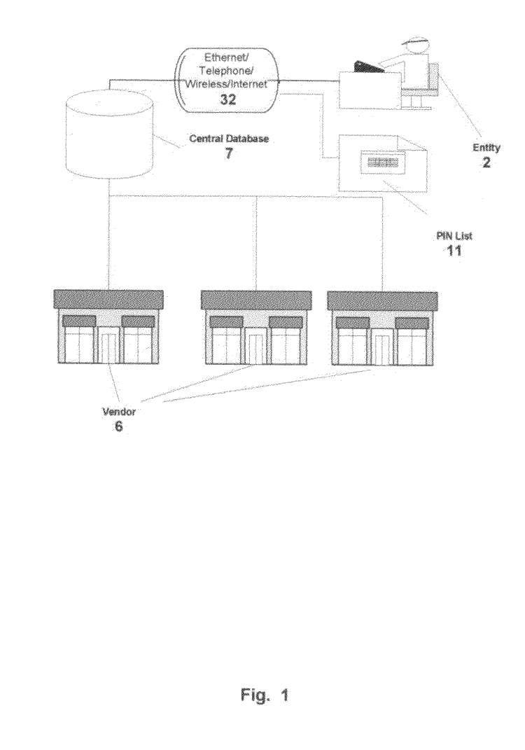

### Description of Process—(Referring to FIG. 1-5)

### Process Overview—Preferred Embodiment

Shown in FIG. 1 is a Multi Account system for executing verifications of transactions. Each vendor 6 uses data input devices as listed above and data communication means 32 for data entry and retrieval into and from the central database 7. Each Entity 2 uses data input devices as listed above and data communication means 32 for data entry and retrieval into and from the central database 7.

The Central Database 7 stores account, personal and bio data entered by Entity 2. It also stores PIN/KEY list 11 entered by the Entity 2. It should be noted that the data stored in the Central Database 7 could be accessed, reviewed and acknowledged by the Entity 2. The Entities will have sets of individualized PINS (key codes or tokens) which one of them may be uniquely associated with, or identify a particular transaction. The PINs/KEYs lists may take the form of password sets, numeric combination, numeric sequence or formula. These PINs/KEYs could also be generated using a predetermined strategy or arbitrary generated by the entity's computer. The PINs/KEYs may include also a predetermined strategy formula to generate further sets of PINs/KEYS that can be used to verify future transactions. Multiple predetermined strategy formulas can be selected from a library stored in the Central Database 7. The Entity 2 can only perform the selection of the appropriate formula stored within the Central Database by using data entry mean.

The PINs/KEYs sets that are entered into and stored within the Central Database can be any suitable manner known in the art, digital signature technology, unique customer coded hardware or software, the use of public/private key encryption techniques or any other suitable form to assure that the keys are selected by the Entity only. The PINs/KEYs can also be generated automatically by the Central Database and then viewed and approved by the Entity. The Central Database 7 will typically store the PINs/KEYs for a predetermined period of time controlled either by the Entity or the Linked Vendors 6. In addition to PINs/KEYs, other personal data can be stored and used for authentication. For example, BIO data, name, social security number, address, date of birth or other personal data elements can be used together with PINs/KEYs for authorization and verification purposes.

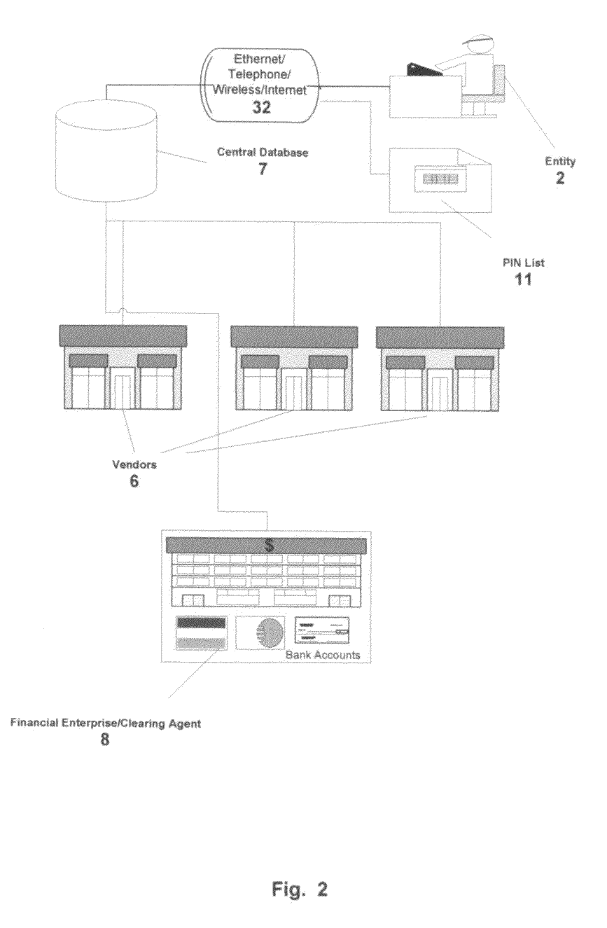

FIG. 2 is a modified version of FIG. 1 and in FIG. 2 the Financial Enterprise/Clearing Agent 8 is added for purposes of clarity and identification having access to the central database 7. In a particular example, the Financial Enterprise/Clearing Agent 8 has access to the central database 7 and can use the data stored in the central database 7 for the purpose of validating account data and authenticating transactions.

In the following description, it should be noted that communication between the Entities 2, Central Database 7 and Financial Enterprises/Clearing Agent 8 may be triggered automatically, for example, by means of a sequential logic process, or through a time schedule system, or alternatively may require a manual intervention to trigger the next phase of an action.

The Central Database 7 is reflected as a separate functional block, it should be understood that the Central Database may be implemented in such a fashion that part or all of its logic can be embedded either within the Vendor's 6 computer, the Financial Enterprise's 8 computer or the Entity's 2 computer.

In a specific embodiment of this system, the Entity 2 enters into the central database 7 lists of PINs and accounts data belonging to several vendors. The Vendors 6 can only retrieve from the central database 7 data related to their accounts belonging to the entity 2. In addition, the Vendors 6 may store in the central database information about account activity, sales events, promotions, coupons and discounts. The entity 2 may access all the vendors 6 data posted in the central database 7 and associated with the vendors' accounts belonging the entity 2.

The Entity 2 may purchase items from the vendors 6 and by sending one of the PINS/Keys 11 to the vendor and at the same time to the Financial Enterprise/Clearing Agent 8, the transaction can be authorized and authenticated. The Financial Enterprise/Clearing Agent 8 has access to the PIN/Key List 11 stored in the Central database 7. It then compares the PIN/KEY, account number and other personal data submitted in the transaction with the data submitted with the Vendor's transaction and uses the data for authentication and authorization.

In another example, internal and external validity for the transaction is performed using the data in the Central Database 7 which in this embodiment is in the Entity's 2 computer. The Entity conducts a transaction with Vendor 6 and submits to the vendor one of the PIN/Keys stored in the central database 7. The Financial Enterprise/Clearing Agent 8 using communication link 32 accesses the data stored in the central database 7 belonging to entity 2. The Financial Enterprise/Clearing Agent 8 uses the accessed data to determine the validity of the transaction and for other transactions based on the PIN list sets stored in the central database.

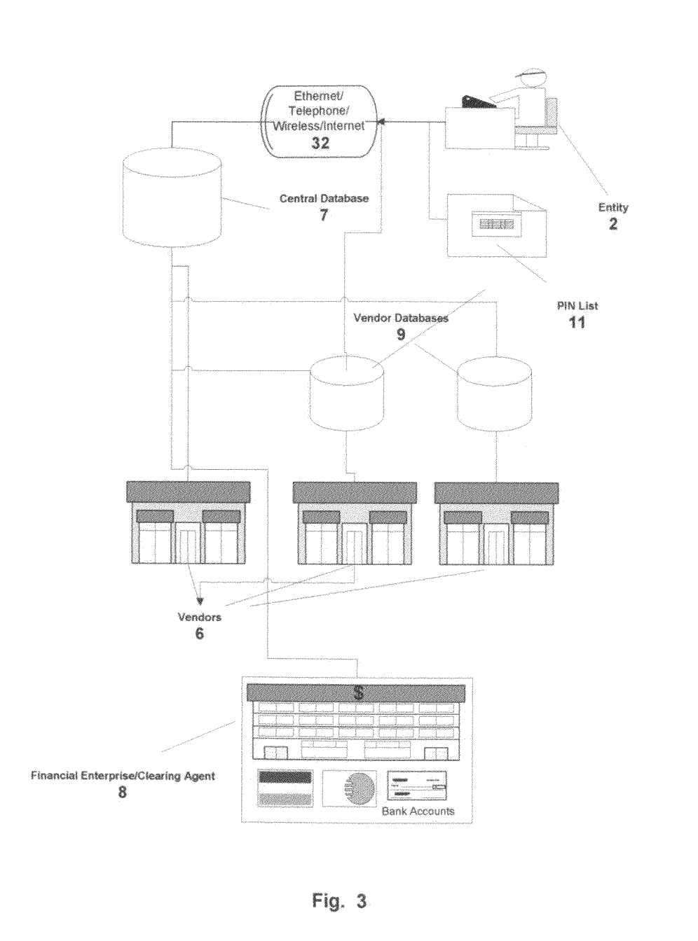

FIG. 3 is a modified version of FIG. 1 and in FIG. 2. Multiple Vendors' databases are added for purposes of clarity and identification as vendor having communication links to the central database 7. In a particular example, the Financial Enterprise/Clearing Agent 8 as well as the vendors 6 have access to the central database 7 and can use the data stored in the central database 7 for the purpose of validating account data and authenticating transactions.

In one other embodiment (Referring to FIG. 3), the Entity's computer may be programmed such that the Entity can directly request to initiate a transaction with the Vendors 6 using communication link 32. The Entity enters details of a transaction and then inputs a transaction PIN/KEY from PIN list 11 into his computer. All the verification processes are processed on-line using communication link 32. In this embodiment, after the Entity 2 had initiated the transaction with the vendor 6, a PIN is sent to the vendor's database 9 and also send to the Financial Enterprise/Clearing Agent 8 using communication means 32. In this embodiment the Vendor 6 will receive from the entity a PIN and at the same time the. Financial Enterprise/Clearing Agent 8 will receive the same PIN. Authentication and authorization is achieved by comparing the PINs.

In a different option of this embodiment PINs/KEYs list 11 may be sent electronically by the entity's to be stored in the Central Database 7 which belongs and directly accessed by Financial Enterprise/Clearing Agent 8.

FIG. 4—FIG. 5 are modified versions of FIG. 3 and include the use of a Data Storage Card 1

Shown in FIG. 4 is a Multi Account System wherein each entity 2 posses one or more Data Storage Cards 1. In this embodiment the entity may use his computer and other means to gain access to the data storage means on card 1. This embodiment (FIG. 5) of the invention includes a bio reader device 16. The bio reader device may include hardware and software components that can be used to sense a characteristic of a user, which uniquely identifies the person as an authorized user. In some embodiments the biometric reader device 16 may include a fingerprint reading device. Alternatively, the reader may include an audio input device, which can be used to identify a user by voice. Alternatively, visual readers for identifying unique visible features or a combination of identifying features of the user may be used. The memory of the card may include data representative of the identifying biometric features of the authorized user or users. This stored data is used to enable authorized users of the card to operate the card while others are prevented from such operation. Once the Entity 2 has properly gained access he may be given the option of changing PIN list stored in the card's its memory or other data items. When an entity 2 needs to perform a transaction, he selects a PIN/Account Serial. The vendor 6 then reads the card data using any conventional card reader device. The card's readable data include account number and selected PIN/Account serial. The vendor 6 then submits the data read from the card in a verification request to the Financial Enterprise 8.

Using Smart Card with Display 12 and Account/PIN Selector

Shown in FIG. 5 is a Multi Account System. Each Entity 2 posses a data storage card 1 constructed as a smart card/RFID card. As shown in FIG. 5 in the embodiment shown, the card may further include an account selector device 25 that includes a manual input device for selecting Account/PIN. The Account/PIN selector 25 can be used for entry or selection of the user's PIN or Control Digits stored as PINS/KEYs list 11. The card also includes an electronic display screen 12 on the front face thereof. In this embodiment of the invention electronic display screen 12 is an LCD type display or other suitable display that may be used for displaying words, graphics and other visible indicia in a manner later explained. When pressing the button or slider 25, the electronic display screen 12 begins a scrolling through the listed accounts in memory. The card then will display the required PIN in the display screen 12 used to select the corresponding account and further can be used for authentication. The card may include only buttons to scroll up/down (button or slider 25). These scroll up and scroll down buttons, are pressed by a user to selectively display items on the display. The card can be used to transmit the required PIN and virtual account to the Vendors 6 and the Financial Enterprise 8 using terminal means and communication means 32. The card's memory may further include data representative of visual indicia, which are found on a plurality of cards or other objects associated with the virtual account. The visible indicia may include for example, bar code indicia representative of a user's real account. Alternatively such visible indicia may include bar code, alpha numeric accounts or other indicia associated with a membership I.D., Credit Cards, Checking Accounts, student I.D., employee access card, driver's license, or other types of objects. The data storage card 1 may include options upon which the stored visible indicia may be reproduced in response to inputs from conventional card readers. This enables visible indicia displayed in display screen 12 to be read, which serves as a substitute for scanning off the card. The card memory may also include data representative of icons or other graphics as well as data representative of real accounts.

### EXAMPLES OF OTHER EMBODIMENTS

Using Wireless Communications Device

Shown in FIG. 5 is a Multi Account System that can be used also with wireless communication data storage card. Each Entity 2 posses data storage card 1 with Wireless communication capabilities whereas the account number assigned to this card (referred in this example as the “device”) is used to communicate with the Vendors 6 or the Financial Enterprises 8. A Vendor 6 data input system is operative to receive account data stored in an entity's hand-held data storage card 1. Data representative of the entity's bio and the entity's virtual account information and selected PINs can be transmitted from the entity's data storage card 1 to the vendor's database 9 using communication links 32. Wireless communication can be used to transmit/receive data between the entity's hand-held card device 1 and the vendors databases 9. The communication may also be encrypted to ensure confidentiality of data.

In one other embodiment (Referring to FIG. 1), the Central Database may reside with the Financial Enterprise/Clearing Agent 8 and programmed such that, Entities 2 will be able to enter account data as described before.

In one other embodiment (Referring to FIG. 1), the Central Database may reside with the Entity's 2 computer and programmed such that, Entity 2 will be able to enter account data as described before, while allowing Vendors 6 and Financial Enterprises 8 access the database using communication links 32.

While only one cycle of each process or method disclosed herein has been described in detail, it should be understood that the processes or methods disclosed herein are designed to be repeated for any one of a number of predetermined times so that transactions, data entry and data validation can be executed between any one of the Vendors and any one of the Financial Enterprises.

In the above embodiments, it should be noted that communication between the Entities, Central Database and Vendors involved in a particular transaction may be triggered automatically, for example, by means of a sequential logic process, or through a time schedule system, or alternatively may require a manual intervention to trigger the next phase of an action.

It is to be understood that the above-described embodiments are merely illustrative of the present invention and that many variations of the above-described embodiments can be devised by those skilled in the art without departing from the scope of the invention. It is therefore intended that such variations be included within the scope of the claims and their equivalents.

1. A multi account system comprising: a Card having generally about the same dimensions as a standard credit card, said card having multiple account storage means, said multiple account storage means including, (a) magnetic strip, (b) smart card, (c) RFID card, (d) bar code, (e) electronic memory, (f) computer, wherein said account storage means are used to store account data,
a Central Database with multiple account numbers linked to said account numbers stored on the said card,
a Data Input means used for data input multiple account data into said Central Database and onto said card, wherein said data including: (a) alpha numeric digits, (b) public keys, (c) private keys, (d) PINs, (e) PANs.

2. The multi account system of claim 1, wherein said central database includes a plurality of said PINS, linked to said multiple account numbers, said PINs, including, (a) secret key sets, (b) public/private key sets, (c) one time key sets.

3. The multi account system of claim 1, wherein said central database includes BIO information linked to said account numbers used for security verification, said BIO information including, (a) fingerprint data, (b) retina data, (c) voice data, (d) physical appearance data, (e) personal data

4. The multi account system of claim 1, wherein said card includes multiple of data storage devices, wherein the said data storage devices are operative to store data associated with at least one account, wherein said data storage devices can be used to store data linked with said accounts.

5. The multi account system of claim 1, wherein said card further comprises terminal interface means for sending and receiving data from outside peripherals and store the said data in the said card data storage devices and the said central database.

6. The multi account system of claim 1, wherein the said card includes memory and one or more writeable magnetic strips, wherein the magnetic strips are adapted to store magnetic strip data associated with the said accounts.

7. The multi account system of claim 1, wherein account numbers can be selected by using input means built into the said card, wherein input means including:, (a) electronic buttons, (b) computer input, (c) mechanical input.

8. A multi account system comprising: a Card having generally about the same dimensions as a standard credit card, said card having multiple account storage means, said multiple account storage means including, (a) magnetic strip, (b) smart card, (c) RFID card, (d) bar code, (e) electronic memory, (f) computer, wherein said account storage means are used to store account data,
One or more central databases with one or more account numbers linked to said multiple account numbers stored on the said card,
one or more vendor databases linked to said central database linked to said multiple account numbers stored on the database,
a Data Input means used for data input into multiple account storage means onto said card, wherein said data including: (a) alpha numeric digits, (b) public keys, (c) private keys, (d) PINs, (e) PANs.

9. The multi account system of claim 8, wherein said central databases and said vendor databases includes a plurality of said PINs, linked to said multiple account numbers, said PINs, including, (a) secret key sets, (b) public/private key sets, (c) one time key sets.

10. The multi account system of claim 8, wherein said central databases includes BIO information linked to said account numbers used for security verification, said BIO information including, (a) fingerprint data, (b) retina data, (c) voice data, (d) physical appearance data, (e) personal data.

11. The multi account system of claim 8, wherein said card includes multiple of data storage devices, wherein the said data storage devices are operative to store data associated with at least one account, wherein said data storage devices can be used to store data linked with said accounts.

12. The multi account system of claim 8, wherein said card further comprises terminal interface means for sending and receiving data from outside peripherals and store the said data in the said card data storage devices.

13. The multi account system of claim 8, wherein the said card includes memory and one or more writeable magnetic strips, wherein the magnetic strips are adapted to store magnetic strip data associated with the account.

14. The multi account system of claim 8, wherein account numbers can be selected by using input means built into the said card, wherein input means including:, (a) electronic buttons, (b) computer input, (c) mechanical input.

15. The multi account system of claim 8, wherein said system further comprises terminal interface means for sending and receiving data from outside peripherals and store the said data in the said central databases and said vendors database.
